(19) United States
(12) Patent Application Publication
(10) Pub. No.: US 2024/0281299 A1
(43) Pub. Date: Aug. 22, 2024

(54) MULTIPLE BMC LOAD SHARING SYSTEM AND METHOD

(71) Applicant: Dell Products, L.P., Round Rock, TX (US)

(72) Inventors: Dharma Bhushan Ramaiah, Bangalore (IN); Vineeth Radhakrishnan, Palakkad (IN); Mini Thottunkal Thankappan, Bangalore (IN); Shinose Abdul Rahiman, Bangalore (IN); Rama Rao Bisa, Bangalore (IN)

(73) Assignee: Dell Products, L.P., Round Rock, TX (US)

(21) Appl. No.: 18/172,994

(22) Filed: Feb. 22, 2023

(51) Int. Cl. G06F 9/50

(52) U.S. Cl. CPC G06F 9/5083

(57) ABSTRACT

In one embodiment, an Information Handling System (IHS) includes multiple Security Protocol and Data Model (SPDM)-enabled devices in communication with multiple Baseboard Management Controllers (BMCs). Each of the BMCs includes executable code to negotiate with the other BMCs, management of a subset of the SPDM-enabled devices based on a hardware capability or a software capability of the SPDM-enabled device relative to the hardware capability or the software capability of the BMC, and manage the subset of devices by the BMC.

### BACKGROUND

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, global communications, etc. In addition, IHSs may include a variety of hardware and software components that may be configured to process, store, and communicate information and may include one or more computer systems, data storage systems, and networking systems.

In modern day IHSs, administrative management is often provided via baseboard management controllers (BMCs). The baseboard management controller (BMC) generally includes a specialized microcontroller embedded on the motherboard of the IHS, and provides an interface between system-management software and platform hardware. Different types of sensors built into the IHS report to the BMC on parameters such as temperature, cooling fan speeds, power status, operating system (O/S) status, and the like. The BMC monitors the sensors and can send alerts to a system administrator via the network if any of the parameters do not stay within pre-set limits, indicating a potential failure of the system. The administrator can also remotely communicate with the BMC to take some corrective actions, such as resetting or power cycling the system to get a hung O/S running again. These abilities save on the total cost of ownership of an IHS, particularly when implemented in large clusters, such as server farms.

### SUMMARY

In one embodiment, an Information Handling System (IHS) includes multiple Security Protocol and Data Model (SPDM)-enabled devices in communication with multiple Baseboard Management Controllers (BMCs). Each of the BMCs includes executable code to negotiate with the other BMCs, management of a subset of the SPDM-enabled devices based on a hardware capability or a software capability of the SPDM-enabled device relative to the hardware capability or the software capability of the BMC, and manage the subset of devices by the BMC.

According to another embodiment, a multiple Baseboard Management Controller (BMC) load sharing method includes the steps of negotiating, by each of a plurality of BMCs, management of a subset of a plurality of Security Protocol and Data Model (SPDM)-enabled devices based on a hardware capability or a software capability of the SPDM-enabled device relative to the hardware capability or the software capability of the BMC, and managing with the other BMCs, the subset of devices by the BMC.

According to yet another embodiment, a computer program product includes a computer readable storage medium having program instructions stored thereon that, upon execution by each of multiple BMCs, cause the respective BMC to negotiate with the other BMCs, management of a subset of a plurality of Security Protocol and Data Model (SPDM)-enabled devices based on a hardware capability or a software capability of the SPDM-enabled device relative to the hardware capability or the software capability of the BMC, and manage the subset of devices by the BMC.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 shows an example of an Information Handling System (IHS) that may be configured to implement multiple Baseboard Management Controller (BMC) load sharing systems and methods according to one embodiment of the present disclosure.

FIG. 2 illustrates an example multiple BMC architecture that may be implemented in an IHS to implement a load balancing system for multiple BMCs according to one embodiment of the present disclosure.

FIGS. 3A and 3B illustrate an example BMC load sharing method that may be performed by the BMCs according to one embodiment of the present disclosure.

FIGS. 4A and 4B illustrate tables representing a capability query command according to one embodiment of the present disclosure.

FIGS. 5A and 5B illustrate tables representing a capability response command according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components. An example of an IHS is described in more detail below.

Certain IHSs may be configured with BMCs that are used to monitor, and in some cases manage computer hardware components of their respective IHSs. A BMC is normally programmed using a firmware stack that configures the BMC for performing out-of-band (e.g., external to a computer's operating system or BIOS) hardware management tasks. The BMC firmware can support industry-standard Specifications, such as the Intelligent Platform Management Interface (IPMI) and Systems Management Architecture of Server Hardware (SMASH) for computer system administration.

Baseboard management controllers (BMCs) are particularly well suited for the features provided by the Security Protocol and Data Model (SPDM) specification. The SPDM specification has been published by the Platform Management Components Intercommunication (PMCI) Working Group of the Distributed Management Task Force (DMTF). A particular goal of the SPDM specification is to facilitate secure communication among the devices of a platform management subsystem. Examples of a platform management subsystem may include an Information Handling System (IHS), such as a desktop computer, laptop computer, a cellular telephone, a server, and the like.

The SPDM specification defines messages and procedures for secure communication among hardware devices, which includes authentication of hardware devices and session key exchange protocols to provide secure communication among those hardware devices. Management Component Transport Protocol (MCTP) Peripheral Component Interconnect Express (PCIe) vendor defined message (VDM) channels, which support peer-to-peer messaging (e.g., route by ID), allow a SPDM-enabled hardware device to issue commands to other SPDM-enabled hardware devices within a secure communication channel.

Cyber attackers are reportedly exploiting and abusing devices, such as platform interface protocol analyzers to steal unencrypted information, spy on network traffic, and gather information to leverage in future attacks against platform components and component interfaces (e.g., I2C, PCIe, I3C, Sensewire, SPI, etc.) of an IHS. Detection of vulnerable platform components is not an easy task, and exploiting unpatched vulnerabilities could allow the attacker to take control of the IHS. Some example platform security risks may include compromised security in which hostile component insertion and compromised firmware updates can cause supply chain security issues. Another example platform security risk may include confidentiality and integrity risks in which data transfers that are unencrypted may be vulnerable to eavesdropping, stealing, and tampering. Additionally, non-compliant security configuration errors, certificate management, platform security trust, and the like could lead to non-compliance with industry standard security policies. The DMTF SPDM specifications have been developed to alleviate such problems and reduce management overhead in maintaining and establishing the platform security within the IHS infrastructure domain.

Newer IHS platforms that are configured with multiple compute nodes and redundant BMCs, which offer High Availability (HA) is gaining in market popularity. That is, a typical server may be configured with multiple, redundant BMCs to increase its effective HA. Although these platforms offer HA for customers to manage the servers, this presents a unique challenge in handling shared resources such as NVMe SSDs. Currently, up to twenty-four (24) NVMe SSDs may be allocated to a single server, and this number is expected to further increase in the future. The PCIe VDM communication requirements, nevertheless, may incur an impact on the input/output (I/O) bandwidth of the devices. The impact on IO bandwidth of a device is aggravated when two or more BMCs are communicating to the same device and issuing same commands. For example, the maximum throughput of a x4 PCIe 3.0 Card, which can be 4 GB/s per direction may incur a loading of approximately 1.25 percent (%). As additional examples, the maximum throughput of a x8 PCIe 3.0 Card, which can be 8 GB/s per direction may incur a loading of approximately 0.625%, while that of a x16 PCIe 3.0 Card, which can be 16 GB/s per direction may incur a loading of approximately 0.3125 percent (%).

When two or more BMCs, which act independently, are implemented in a single computing node, it may incur certain challenges. SPDM Device attestation may involve two or more BMCs that may be required to attest the same set of devices, a condition that could lead to undue compute and communication overhead. SPDM firmware measurement also presents a challenge in which two or more BMCs may be required to monitor the firmware measurements from the same set of devices routinely at regular intervals, which may again lead to computation and communication overhead in both BMCs and the devices that they manage. Hot plug devices are typically attested by all the BMCs in the system, thus incurring further bandwidth and computational loading. As will be described in detail herein below, embodiments of the present disclosure provide techniques and services for delegating management responsibilities to each of multiple BMCs based on a hardware capability or a software capability of the SPDM-enabled device relative to the hardware capability or the software capability of the BMC. As will be described in detail herein below, embodiments of the present disclosure may provide a solution to these problems, among others, by providing load balancing for multiple BMCs configured in an IHS so that the performance capabilities of each BMC may be optimally suited for the tasks to which they are assigned.

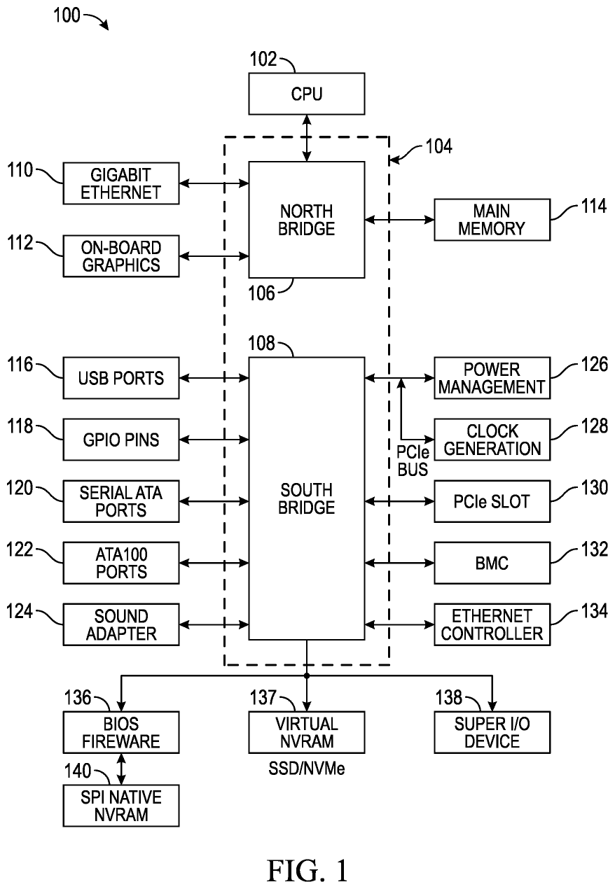

FIG. 1 shows an example of an IHS 100 configured to implement embodiments described herein. It should be appreciated that although certain embodiments described herein may be discussed in the context of a desktop or server computer, other embodiments may be utilized with virtually any type of IHS. Particularly, the IHS 100 includes a baseboard or motherboard, which is a printed circuit board (PCB) to which components or devices are mounted by way of a bus or other electrical communication path. For example, Central Processing Unit (CPU) 102 operates in conjunction with a chipset 104. CPU 102 is a processor that performs arithmetic and logic necessary for the operation of the IHS 100.

Chipset 104 includes northbridge 106 and southbridge 108. Northbridge 106 provides an interface between CPU 102 and the remainder of the IHS 100. Northbridge 106 also provides an interface to a random access memory (RAM) used as main memory 114 in the IHS 100 and, possibly, to on-board graphics adapter 112. Northbridge 106 may also be configured to provide networking operations through Ethernet adapter 110. Ethernet adapter 110 is capable of connecting the IHS 100 to another IHS (e.g., a remotely located IHS) via a network. Connections which may be made by Ethernet adapter 110 may include local area network (LAN) or wide area network (WAN) connections. Northbridge 106 is also coupled to southbridge 108.

Southbridge 108 is responsible for controlling many of the input/output (I/O) operations of the IHS 100. In particular, southbridge 108 may provide one or more universal serial bus (USB) ports 116, sound adapter 124, Ethernet controller 134, and one or more general purpose input/output (GPIO) pins 118. Southbridge 108 may also provide a bus for interfacing peripheral card devices such as PCIe slot 130. In some embodiments, the bus may include a peripheral component interconnect (PCI) bus. Southbridge 108 may also provide baseboard management controller (BMC) 132 for use in managing the various components of the IHS 100. Power management circuitry 126 and clock generation circuitry 128 may also be utilized during operation of southbridge 108.

Additionally, southbridge 108 is configured to provide one or more interfaces for connecting mass storage devices to the IHS 100. For instance, in an embodiment, southbridge 108 may include a serial advanced technology attachment (SATA) adapter for providing one or more serial ATA ports 120 and/or an ATA100 adapter for providing one or more ATA100 ports 122. Serial ATA ports 120 and ATA100 ports 122 may be, in turn, connected to one or more mass storage devices storing an operating system (OS) and application programs.

An OS may comprise a set of programs that controls operations of the IHS 100 and allocation of resources. An application program is software that runs on top of the OS and uses computer resources made available through the OS to perform application-specific tasks desired by the user.

Mass storage devices connected to southbridge 108 and PCIe slot 130, and their associated computer-readable media provide non-volatile storage for the IHS 100. Although the description of computer-readable media contained herein refers to a mass storage device, such as a hard disk or CD-ROM drive, it should be appreciated by a person of ordinary skill in the art that computer-readable media can be any available media on any memory storage device that can be accessed by the IHS 100. Examples of memory storage devices include, but are not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices.

A low pin count (LPC) interface may also be provided by southbridge 108 for connecting Super I/O device 138. Super I/O device 138 is responsible for providing a number of I/O ports, including a keyboard port, a mouse port, a serial interface, a parallel port, and other types of input/output ports.

The LPC interface may connect a computer storage media such as a ROM or a flash memory such as a non-volatile random access memory (NVRAM) for storing BIOS/firmware 136 that includes BIOS program code containing the basic routines that help to start up the IHS 100 and to transfer information between elements within the IHS 100. BIOS/firmware 136 comprises firmware compatible with the Extensible Firmware Interface (EFI) Specification and Framework.

The LPC interface may also be utilized to connect virtual NVRAM 137 (e.g., SSD/NVMe) to the IHS 100. The virtual NVRAM 137 may be utilized by BIOS/firmware 136 to store configuration data for the IHS 100. In other embodiments, configuration data for the IHS 100 may be stored on the same virtual NVRAM 137 as BIOS/firmware 136. The IHS 100 may also include a SPI native NVRAM 140 coupled to the BIOS 136.

BMC 132 may include non-volatile memory having program instructions stored thereon that enable remote management of the IHS 100. For example, BMC 132 may enable a user to discover, configure, and manage the IHS 100, setup configuration options, resolve and administer hardware or software problems, etc. Additionally or alternatively, BMC 132 may include one or more firmware volumes, each volume having one or more firmware files used by the BIOS' firmware interface to initialize and test components of the IHS 100.

As a non-limiting example of BMC 132, the integrated DELL Remote Access Controller (iDRAC) from DELL, INC. is embedded within DELL POWEREDGE servers and provides functionality that helps information technology (IT) administrators deploy, update, monitor, and maintain servers with no need for any additional software to be installed. The iDRAC works regardless of OS or hypervisor presence from a pre-OS or bare-metal state because iDRAC is embedded within the IHS 100 from the factory.

It should be appreciated that, in other embodiments, the IHS 100 may comprise other types of computing devices, including hand-held computers, embedded computer systems, personal digital assistants, and other types of computing devices. It is also contemplated that the IHS 100 may not include all of the components shown in FIG. 1, may include other components that are not explicitly shown in FIG. 1, or may utilize a different architecture.

According to embodiments of the present disclosure, the IHS 100 may support SPDM in which the BMC 132 manages the operation of one or more managed devices configured in the IHS 100. Managed devices may include any SPDM-enabled device, such as on-board graphics adapter 112, Ethernet adapter 110, USB ports 116, sound adapter 124, Ethernet controller 134, GPIO pins 118, PCIe slot 130, Power management circuitry 126, clock generation circuitry 128, serial ATA ports 120, ATA100 ports 122, virtual NVRAM 137, SPI native NVRAM 140, and Super I/O device 138 as described herein above. The SPDM specification provides for secure communication between the BMC 132 and the managed devices in the IHS 100. To meet this goal, the SPDM specification facilitates certificate chains that are stored in up to eight slots. Slot 0 is a default slot that is always used, while the other slots (e.g., slots 1-7) may be allocated for use by the administrator of the IHS 100. The SPDM spec also provides a slot mask that identifies each certificate chain.

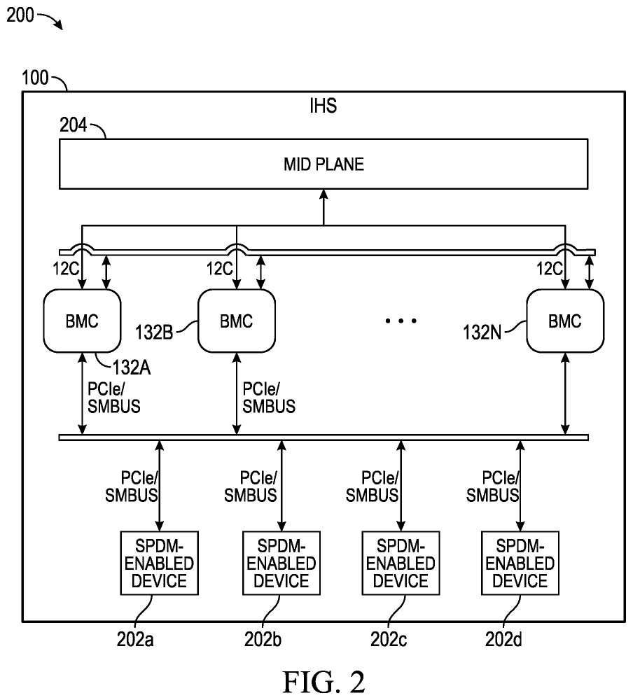

FIG. 2 illustrates an example multiple BMC architecture 200 that may be implemented in an IHS 100 to implement a load balancing system for multiple BMCs according to one embodiment of the present disclosure. The multiple BMC architecture 200 includes multiple BMCs 132a-n (collectively 132) in communication with multiple SPDM-enabled devices 202a-n (collectively 202), and a mid-plane 204 that are configured in an IHS 100. For example, IHS 100 may be a server configured in a cluster, such as a data center. The BMCs 132 may communicate with the SPDM-enabled devices 202 and/or mid plane 204 using any suitable type of communication link, such as an inter-integrated circuit (I2C) connection, an i3c SENSEWIRE connection, or a serial peripheral interface (SPI) based connection. Within this disclosure, a SPDM-enabled device 202 may refer to any computer-implementable device that operates with at least a portion of the features specified in the SPDM specification.

Current IHS platforms implemented with multiple BMCs typically utilize peer to peer serial communication. This communication channel can be leveraged to solve some, most, or all problems described above. In one embodiment, the BMCs 132 communicate with each other, the mid plane 204 and the devices 202 using a I2C serial bus. Although three BMCs 132 are shown, it should be appreciated that the system may be implemented with any two or more BMCs 132 configured in the IHS 100.

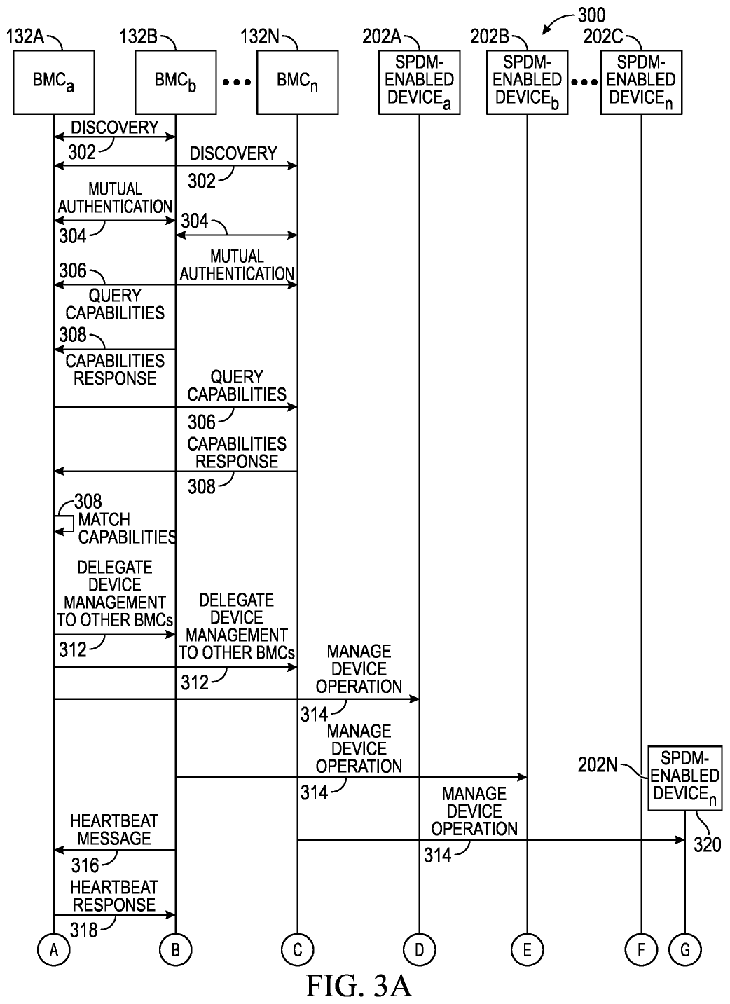

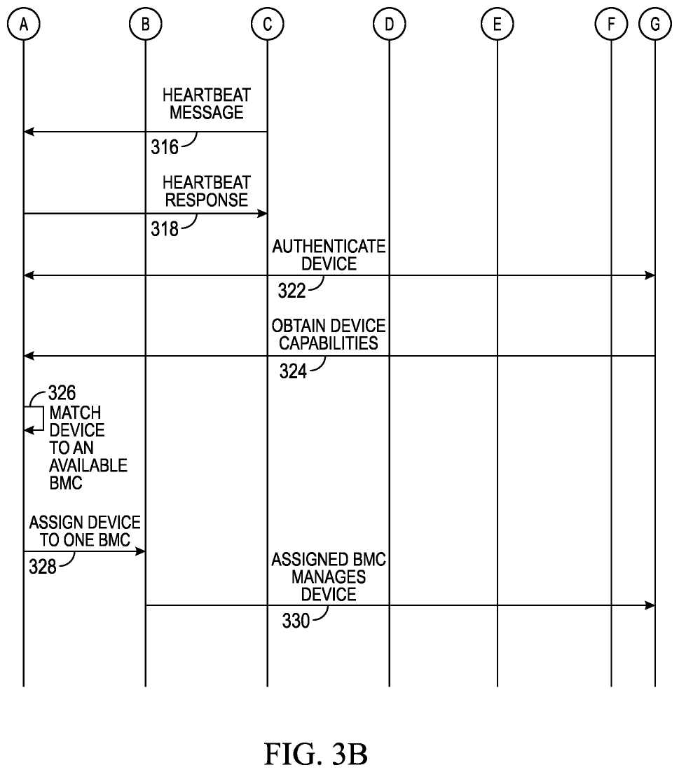

FIG. 3 illustrates an example BMC load sharing method 300 that may be performed by the BMCs 132 according to one embodiment of the present disclosure. The method 300 may be performed at any suitable time. In one embodiment, the method 300 is performed each time the IHS 100 configured with the BMCs 132 and SPDM-enabled devices 204 is cold booted, warm booted, and/or with an on chip request (OCR).

Initially, such as in response to booting of the IHS 100, a designated master BMC 132 performs a discovery process to identify other BMCs 132 in the IHS 100 at step 302. Only one BMC 132 shall be designated as master, and it is designated as master using any suitable means. In one embodiment, a BMC 132 configured with an I2C address of 0x1 shall initially designated as master. As shown in FIG. 3, BMC 132a is currently designated as master.

At step 304, each of the identified BMCs 132 mutually authenticate with one another using the SPDM protocol over the I2C interface. Should authentication between any pair of BMCs 132 fail, the BMC 132 detecting the failed authentication process may generate an alert message, which may be sent to a remotely configured console. Thereafter at step 306, the master BMC 132a queries each of the other BMCs 132 to advertise their respective capabilities. The capabilities of each BMC 132 may include, for example, a firmware version currently being executed on the BMC 132, a type (e.g., vendor supplied firmware, custom firmware, such as openBMC firmware) of firmware currently being executed on the BMC 132, a quantity of processor cores configured on the BMC 132, clock speed of the processors, an amount of available memory, other processors configured on the BMC 132, and the like.

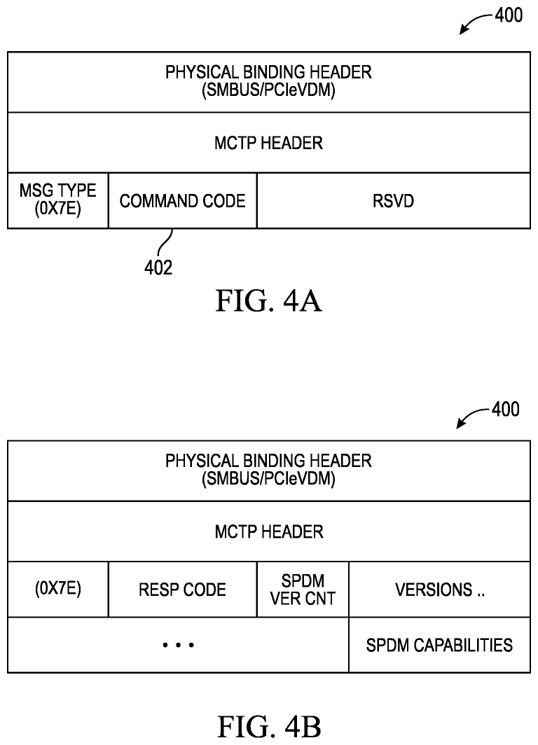

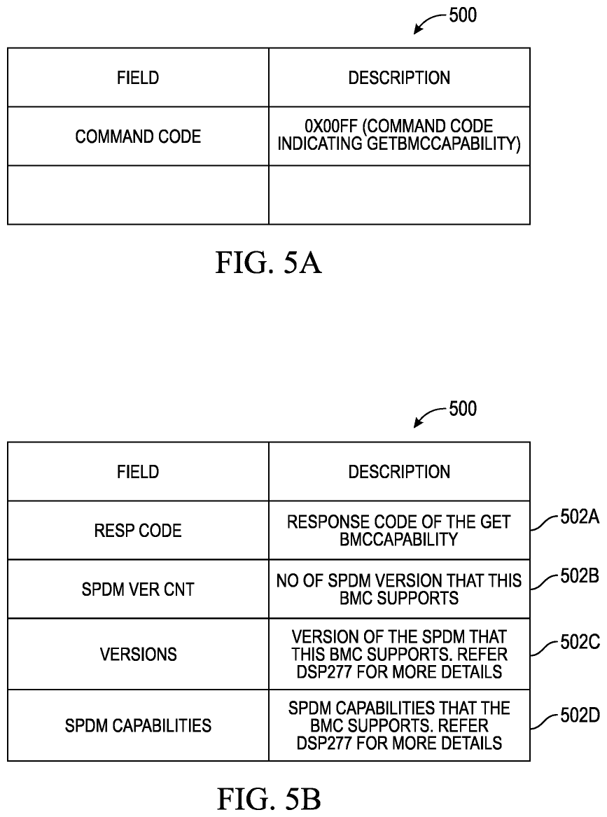

In one embodiment, an Original Equipment Manufacturer (OEM) command may be implemented to obtain the capabilities from the other BMCs 132. For example, FIGS. 4A and 4B illustrate tables representing a capability query command 400, while FIGS. 5A and 5B illustrate tables representing a capability response command 500. When the master BMC 132a queries the other BMCs 132, it may generate the capability query command 400 that includes a command code 402 indicating to all receiving BMCs 132b-n that the master BMC 132a is querying for their respective capabilities. In response, each of the other BMCs 132a-n generates the capability response command 500 that includes certain fields 502a-d indicating their capabilities. As shown, for example, advertised capabilities may include a number of SPDM version that the BMC 132 supports, a version of SPDM that the BMC 132 supports, and SPDM capabilities that the BMC 132 supports. Nevertheless, it should be appreciated that the capability response command 500 may be configured to indicate any desired capability associated with the BMC 132 without departing from the spirit and scope of the present disclosure.

Referring again to FIG. 3, the master BMC 132a receives the capability response command 500 from the other BMCs 132b-n at step 308. Using the capabilities received in the capability response command 500, the master BMC 132a matches the capabilities of the BMCs 132 with the capabilities of the devices 202 at step 310. That is, the master BMC 132a delegate certain devices 202 to be managed by a certain BMC 132 due to their combination of capabilities, while delegating other device 202 to be managed by a different BMC 132 due to another combination of capabilities. For example, the master BMC 132a may assign a device with SPDM 1.2 version support to a BMC which supports SPDM 1.2, and assign a device with SPDM 1.1 version support to a BMC which supports SPDM 1.1.

In one embodiment, the master BMC 132a may match certain devices 202 with certain BMCs 132 according to load balancing. For example, even if one BMC 132 may be optimally configured to manage eight out of ten devices 202 configured in the IHS 100, the master BMC 132a may delegate only three or four of the devices 202 to the one BMC 132 so that the other BMCs 132 may assist in sharing the processing load of the one BMC 132. As another example, the master BMC 132a may obtain loading information from each of the other BMCs 132b-n in the form of available capacity (e.g., 54 percent (%) of maximum processing load), and match devices 202 to their assigned BMCs 132 such that their available capacity remains relatively similar to one another. Thus, the BMCs 132 may share the load among multiple BMCs, aggregate the device authentication status, and share the collective status among the other BMCs 132 in the IHS 100. A similar technique may be used for sharing the firmware measurements, thus avoiding each BMC being required to query every device in the server.

At step 312, the master BMC 132a delegates device management to the other BMCs 132b-n by sending a message to each other BMC 132, information about which devices 202 they have been delegated to manage. As shown in the example scenario of FIG. 3, BMC 132a (e.g., the master BMC) is delegated to manage the operation of device 202a, BMC 132b is delegated to manage the operation of device 202b, while BMC 132n is delegated to manage the operation of device 202c. Nevertheless, it should be understood that the master BMC 132a may delegate any device 202 to any BMC 132 based upon their capabilities and/or load sharing of their resources.

The BMCs 132 may thus independently manage each of their delegated devices 202 at step 314. The BMC 132 may utilize any suitable type of management operation on their respective devices 202. In one embodiment, each BMC 132 may independently perform SPDM attestation with their respective devices 202. In another embodiment, each BMC 132 may independently perform firmware measurements on their respective devices 202. In yet another embodiment, each BMC 132 may periodically query the firmware measurements of their delegated devices 202 and share the result with other BMCs 132 only when invalid measurement or a change in measurement is detected.

At step 316, each of the other BMCs 132b-n may send heartbeat messages to the master BMC 132a at ongoing intervals (e.g., periodically) to ensure that it is functioning properly. In response at step 318, the master BMC 132a responds by sending a heartbeat response message to the other BMCs 132b-n. If the heartbeat response message is not received by either of the other BMCs 132b-n, they may perform a negotiation process to identify a new master BMC 132b-n from among the remaining, functional BMCs 132b-n. Any suitable negotiation process may be used. In one embodiment, the BMCs 132b-n may select the BMC with the next lowest I2C address (e.g., 0x2) to be designated as master.

Steps 320-330 generally describe the steps that may be taken when a device 202 is hot plugged into the IHS 100. At step 320, a device 202n is hot plugged into the IHS 100. The master BMC 132a detects the hot plug event and in response, authenticates the new device 202 at step 322. At step 324, the master BMC 132a obtains device capabilities from the newly plugged device 202d, such as via use of the capabilities query command 400 described above with reference to FIGS. 4A and 4B. Thereafter at step 326, the master BMC 132a matches the newly plugged device 202d to one BMC. In one embodiment, the newly plugged device 202d is matched to a BMC 132 in a manner similar to the actions performed above with reference to step 310. At step 328, the master BMC 132a delegates the newly plugged device 202d to the matched BMC, which in the present example scenario, is BMC 132b. Thereafter at step 330, BMC 132b manages the operation of the hot plugged device 202d.

The method 300 described above may be repeatedly performed for ongoing management of the devices 202 of the IHS 100 by multiple BMCs 132 using a load balancing algorithm. For example, steps 316 and 318 may be repeatedly performed at ongoing intervals, such that should the master BMC 132a become non-functional, another BMC 132b-n may be designated as the master. Later on when the BMC 132a again becomes functional and the newly designated master becomes non-functional, BMC 132a may again resume the duties of the master. As another example, steps 320-330 may be performed each time a new device 202 is hot plugged in the IHS 100. Nevertheless, when use of the multiple BMC load sharing method 300 is no longer needed or desired, the method ends.

Although FIG. 3 describes an example method 300 that may be performed for load sharing among multiple BMCs 132, the features of the method 300 may be embodied in other specific forms without deviating from the spirit and scope of the present disclosure. For example, the method 300 may perform additional, fewer, or different operations than those described in the present examples. For another example, the method 300 may be performed in a sequence of steps different from that described above. As yet another example, certain steps of the method 300 may be performed by other components in the IHS 100 other than those described above.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” when used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS) comprising:
a plurality of Security Protocol and Data Model (SPDM)-enabled devices; and
a plurality of Baseboard Management Controllers (BMCs) in communication with the SPDM-enabled devices, the BMCs each comprising a processor and a memory coupled to the at least one processor, the memory having program instructions stored thereon that, upon execution by the processor, cause each of the BMCs to:
negotiate with the other BMCs, management of a subset of the SPDM-enabled devices based on a hardware capability or a software capability of the SPDM-enabled device relative to the hardware capability or the software capability of the BMC; and
manage the subset of devices by the BMC.

2. The IHS of claim 1, wherein the program instructions, upon execution, further cause each of the BMCs to:
perform SPDM attestation with the subset of devices; and
share the results of the SPDM attestation with the other BMCs.

3. The IHS of claim 1, wherein the program instructions, upon execution, further cause each of the BMCs to:
obtain firmware measurements of the subset of devices; and
share the results of the firmware measurements with the other BMCs.

4. The IHS of claim 1, wherein the program instructions, upon execution, further cause each of the BMCs to negotiate with the other BMCs, management of the subset of devices based upon a load sharing technique.

5. The IHS of claim 1, wherein the program instructions, upon execution, further cause each of the BMCs to:
perform a discovery process to discover the other BMCs in the IHS;
perform mutual authentication with each of the discovered BMCs; and
when the mutual authentication fails, generate an alert message that indicates the failed authentication.

6. The IHS of claim 1, wherein the program instructions, upon execution, further cause each of the BMCs to:
when the BMC is not designated as a master BMC, generate a heartbeat message at ongoing intervals;
transmit the heartbeat message to the master BMC; and
when no valid response is received, negotiate a new master BMC with the other remaining BMCs.

7. The IHS of claim 1, wherein the program instructions, upon execution, further cause each of the BMCs to:
when the BMC is designated as a master BMC, receive an indication that a new SPDM-enabled device has generated a hot plug event;
authenticate the new SPDM-enabled device; and
assign another one of the BMCs to manage the new device according to at least one of the hardware capability or the software capability of the SPDM-enabled device relative to the hardware capability or the software capability of the BMC, or a load sharing technique.

8. The IHS of claim 7, wherein the program instructions, upon execution, further cause each of the BMCs to designate the BMC as the master BMC according to a communication link address assigned to the BMC.

9. The IHS of claim 1, wherein the program instructions, upon execution, further cause each of the BMCs to, when the IHS is initially turned on, query each of the other BMCs for their capabilities using a custom SPDM-based Original Equipment Manufacturer (OEM) command.

10. A multiple Baseboard Management Controller (BMC) load sharing method comprising:
negotiating, by each of a plurality of BMCs, with the other BMCs, management of a subset of a plurality of Security Protocol and Data Model (SPDM)-enabled devices based on a hardware capability or a software capability of the SPDM-enabled device relative to the hardware capability or the software capability of the BMC; and
managing the subset of devices by the BMC.

11. The multiple BMC load sharing method of claim 10, further comprising:
performing SPDM attestation with the subset of devices; and
sharing the results of the SPDM attestation with the other BMCs.

12. The multiple BMC load sharing method of claim 10, further comprising wherein the program instructions, upon execution, further cause each of the BMCs to:
obtain firmware measurements of the subset of devices; and
share the results of the firmware measurements with the other BMCs.

13. The multiple BMC load sharing method of claim 10, further comprising negotiating with the other BMCs, management of the subset of devices based upon a load sharing technique.

14. The multiple BMC load sharing method of claim 10, further comprising:
performing a discovery process to discover the other BMCs in the IHS; and
performing mutual authentication with each of the discovered BMCs; and
when the mutual authentication fails, generating an alert message that indicates the failed authentication.

15. The multiple BMC load sharing method of claim 10, further comprising wherein the program instructions, upon execution, further cause each of the BMCs to:
when the BMC is not designated as a master BMC, generate a heartbeat message at ongoing intervals;
transmit the heartbeat message to the master BMC; and
when no valid response is received, negotiate a new master BMC with the other remaining BMCs.

16. The multiple BMC load sharing method of claim 10, further comprising:
when the BMC is designated as a master BMC, receiving an indication that a new SPDM-enabled device has generated a hot plug event;
authenticating the new SPDM-enabled device; and
assigning another one of the BMCs to manage the new device according to at least one of the hardware capability or the software capability of the SPDM-enabled device relative to the hardware capability or the software capability of the BMC, or a load sharing technique.

17. The multiple BMC load sharing method of claim 16, further comprising designating the BMC as the master BMC according to a communication link address assigned to the BMC.

18. The multiple BMC load sharing method of claim 10, further comprising, when the IHS is initially turned on, querying each of the other BMCs for their capabilities using a custom SPDM-based Original Equipment Manufacturer (OEM) command.

19. A computer program product comprising a computer readable storage medium having program instructions stored thereon that, upon execution by each of a plurality of Baseboard Management Controllers (BMCs), cause the respective BMC to:
negotiate with the other BMCs, management of a subset of a plurality of Security Protocol and Data Model (SPDM)-enabled devices based on a hardware capability or a software capability of the SPDM-enabled device relative to the hardware capability or the software capability of the BMC; and
manage the subset of devices by the BMC.

20. The computer program product of claim 19, wherein the program instructions, upon execution, further cause each of the BMCs to negotiate with the other BMCs, management of the subset of devices based upon a load sharing technique.
